(19) United States
(12) Patent Application Publication
(10) Pub. No.: US 2010/0138268 A1
(43) Pub. Date: Jun. 3, 2010

(54) PROGRESS MANAGEMENT PLATFORM

(75) Inventors: Aiqun GUO, Weston, MA (US); Yi JING, Cambridge, MA (US); Jiang LAN, Walpole, MA (US); Harry LU, Bedford, MA (US)

Correspondence Address: VERIZON;PATENT MANAGEMENT GROUP, 1320 North Court House Road, 9th Floor, ARLINGTON, VA, 22201-2909, US

(73) Assignee: VERIZON BUSINESS NETWORK SERVICES, INC., Ashburn, VA (US)

(21) Appl. No.: 12/325,544

(22) Filed: Dec. 1, 2008

(51) Int. Cl. G06Q 10/00

(52) U.S. Cl. 705/9; 705/7; 705/8

(57) ABSTRACT

A device receives milestone information and dependency information associated with a project, generates a milestone flow chart based on the milestone information and the dependency information, and represents one or more milestones, in the milestone flow chart, with one or more nodes. The device also represents one or more dependencies among the one or more milestones with one or more directed arcs provided between corresponding nodes of the one or more nodes, and calculates a critical path associated with the one or more milestones. The device further represents the critical path with bolded directed arcs provided between corresponding nodes of the one or more nodes, and provides the milestone flow chart, including the representations of the one or more milestones, the one or more dependencies, and the critical path, for display.

### BACKGROUND

Project planning (or project/progress management) relates to the use of schedules such as Gantt charts to plan and subsequently report progress associated with a project. A project may be a finite endeavor (e.g., that includes specific start and completion dates) undertaken to create a product and/or a service. In project planning, a project scope may be defined and appropriate methods for completing the project may be determined. Following this step, durations for various tasks necessary to complete the project may be listed and grouped into a work breakdown structure. Logical dependencies between the tasks may then be defined using an activity network diagram that enables identification of a critical path. Float or slack time in the schedule can be calculated using project management software. Necessary resources may be estimated and costs for each task may be allocated to each resource in order to provide a total project cost. At this stage, the project plan may be optimized to achieve an appropriate balance between resource usage, project duration, and project objectives. Once established and agreed upon, the project plan may provide one or more baselines (or milestones). Progress may be measured against the milestones throughout the life of the project.

Current project management software includes open source project management software and commercial project management software. Open source project management software supports a single browser platform, but fails to support multiple browser platforms. Commercial project management software may include several project planning features. However, such commercial project management software is expensive, is difficult to use, and is difficult to customize.

### BRIEF DESCRIPTION OF THE DRAWINGS

FIG. 1 depicts a diagram of an exemplary network in which systems and/or methods described herein may be implemented;

FIG. 2 illustrates a diagram of exemplary components of a user device, a progress management server, and/or an ebonding server of the network depicted in FIG. 1;

FIG. 3 depicts a diagram of a portion of an exemplary computer-readable medium that may be used by the user device, progress management server, and/or ebonding server of the network illustrated in FIG. 1;

FIG. 4 illustrates a diagram of exemplary operations capable of being performed by an exemplary portion of the network depicted in FIG. 1;

FIGS. 5A and 5B depict diagram of exemplary user interfaces for displaying a generated model that is capable of being generated by the user device, progress management server, and/or ebonding server of the network illustrated in FIG. 1;

FIG. 6 illustrates a diagram of an exemplary user interface for displaying a graphic flow chart of milestones associated with a project that is capable of being generated by the user device, progress management server, and/or ebonding server of the network depicted in FIG. 1;

FIGS. 7 and 8 depict a diagram of exemplary user interfaces for displaying graphic flow charts of tasks associated with milestones that are capable of being generated by the user device, progress management server, and/or ebonding server of the network illustrated in FIG. 1; and

FIGS. 9-12 depict a flow chart of an exemplary process according to implementations described herein.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Systems and/or methods described herein may provide a progress management platform that creates a progress management model based on milestones, tasks, and/or dependencies associated with a project, and that creates intuitive and interactive project flow charts that include dependencies and critical paths among tasks. In one implementation, for example, the systems and/or methods may receive milestone, task, and/or dependency information associated with a project, may generate a progress management model based on the received information, and may provide the progress management model for display. The systems and/or methods may generate a milestone flow chart, with dependencies among milestones, based on the milestone information and associated dependency information, and may provide the milestone flow chart for display. The systems and/or methods may generate a task flow chart, with dependencies among tasks, based on the task information and associated dependency information, may provide the task flow chart for display, and may provide, to one or more users, one or more notifications associated the milestone and task flow charts.

A “project,” as the term is used herein, is to be broadly construed to include an endeavor (e.g., that includes specific start and completion dates) undertaken to create a product and/or a service. For example, in one implementation, a project may include one or more tasks that may be performed in order to create a product and/or a service. One or more project tasks may be dependent upon (or form dependencies with) one or more other project tasks. One or more project tasks may form what is called a “milestone” (e.g., a baseline against which progress may be measured throughout the life of the project).

A “product,” as the term is used herein, is to be broadly interpreted to include any thing that may be marketed or sold as a commodity or a good. For example, in one implementation, a product may include a device, such as a radiotelephone, a personal communications system (PCS) terminal, a personal digital assistant (PDA), a laptop, a personal computer, other types of computation or communication devices, etc.

A “service,” as the term is used herein, is to be broadly interpreted to include any act or variety of work done for others (e.g., for compensation). For example, in one implementation, a service may include telecommunication services, such as telephone services, Internet services, network services, radio services, television services, video services, etc.

As used herein, the term “user” is intended to be broadly interpreted to include a user device and/or a progress management server or a user of a user device and/or a progress management server. In one example, a user may include one or more individuals associated with a project (e.g., a project manager, a person performing project tasks, an external customer, etc.).

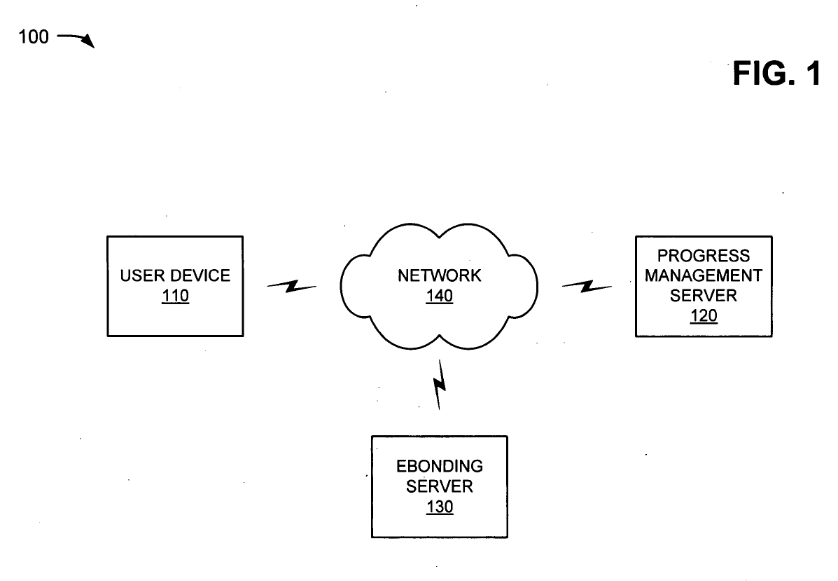

FIG. 1 is a diagram of an exemplary network 100 in which systems and/or methods described herein may be implemented. As illustrated, network 100 may include a user device 110, a progress management server 120, and an ebonding server 130 interconnected by a network 140. Components of network 100 may interconnect via wired and/or wireless connections. A single user device 110, progress management server 120, ebonding server 130, and network 140 have been illustrated in FIG. 1 for simplicity. In practice, there may be more user devices 110, progress management servers 120, ebonding servers 130, and/or networks 140. Also, in some instances, one or more of the components of network 100 may perform one or more functions described as being performed by another one or more of the components of network 100.

User device 110 may include any device that is capable of accessing progress management server 120 via network 140. For example, user device 110 may include a radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a laptop computer, a personal computer, or other types of computation or communication devices, threads or processes running on these devices, and/or objects executable by these devices. User device 110 may enable a user to interact with a progress management platform (e.g., provided on user device 110 and/or on progress management server 120), and to view, manage, provide information to, receive information from, receive notifications from, etc. one or more projects associated with the progress management platform. In one example, user device 110 may provide milestone, task, and/or dependency information associated with a project to progress management server 120, and may receive a model and/or one or more graphic flow charts associated with the project from progress management server 120.

Progress management server 120 may include one or more server entities, or other types of computation or communication devices, that gather, process, search, and/or provide information in a manner described herein. In one implementation, progress management server 120 may receive milestone, task, and/or dependency information associated with a project, and may generate a progress management model based on the received information. Progress management server 120 may generate a milestone flow chart, with dependencies, based on the milestone information and associated dependency information, and may generate a task flow chart, with dependencies, based on the task information and associated dependency information. Progress management server 120 may provide the milestone flow chart, the task flow chart, and/or project notifications to one or more users (e.g., associated with user device 110 and/or progress management server 120).

Ebonding server 130 may include one or more server entities, or other types of computation or communication devices, that gather, process, search, and/or provide information in a manner described herein. In one implementation, ebonding server 130 may interact with project management server 120 in order to automate task execution of a project generated by project management server 120, to revise milestone, task, and/or dependency information associated with the project, and to generate a new progress management model based on the revised information.

Network 140 may include a local area network (LAN), a wide area network (WAN), a metropolitan area network (MAN), a telephone network, such as the Public Switched Telephone Network (PSTN), an intranet, the Internet, an optical fiber (or fiber optic)-based network, or a combination of networks.

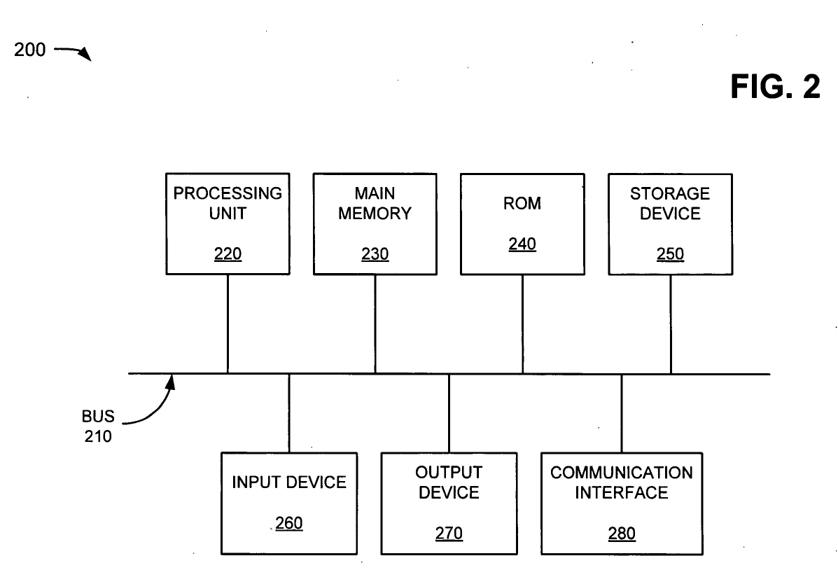

FIG. 2 illustrates a diagram of exemplary components of a device 200 that may correspond to user device 110 and/or progress management server 120. As illustrated, device 200 may include a bus 210, a processing unit 220, a main memory 230, a read-only memory (ROM) 240, a storage device 250, an input device 260, an output device 270, and/or a communication interface 280. Bus 210 may include a path that permits communication among the components of device 200.

Processing unit 220 may include one or more processors, microprocessors, or other types of processing units that may interpret and execute instructions. Main memory 230 may include a random access memory (RAM) or another type of dynamic storage device that may store information and instructions for execution by processing unit 220. ROM 240 may include a ROM device or another type of static storage device that may store static information and/or instructions for use by processing unit 220. Storage device 250 may include a magnetic and/or optical recording medium and its corresponding drive.

Input device 260 may include a mechanism that permits an operator to input information to device 200, such as a keyboard, a mouse, a pen, a microphone, voice recognition and/or biometric mechanisms, a remote control, a touch screen, etc. Output device 270 may include a mechanism that outputs information to the operator, including a display, a printer, a speaker, etc. Communication interface 280 may include any transceiver-like mechanism that enables device 200 to communicate with other devices and/or systems. For example, communication interface 280 may include mechanisms for communicating with another device or system via a network, such as network 140.

As described herein, device 200 may perform certain operations in response to processing unit 220 executing software instructions contained in a computer-readable medium, such as main memory 230. A computer-readable medium may be defined as a physical or logical memory device. The software instructions may be read into main memory 230 from another computer-readable medium, such as storage device 250, or from another device via communication interface 280. The software instructions contained in main memory 230 may cause processing unit 220 to perform processes described herein. Alternatively, hardwired circuitry may be used in place of or in combination with software instructions to implement processes described herein. Thus, implementations described herein are not limited to any specific combination of hardware circuitry and software.

Although FIG. 2 shows exemplary components of device 200, in other implementations, device 200 may contain fewer, different, or additional components than depicted in FIG. 2. In still other implementations, one or more components of device 200 may perform one or more other tasks described as being performed by one or more other components of device 200.

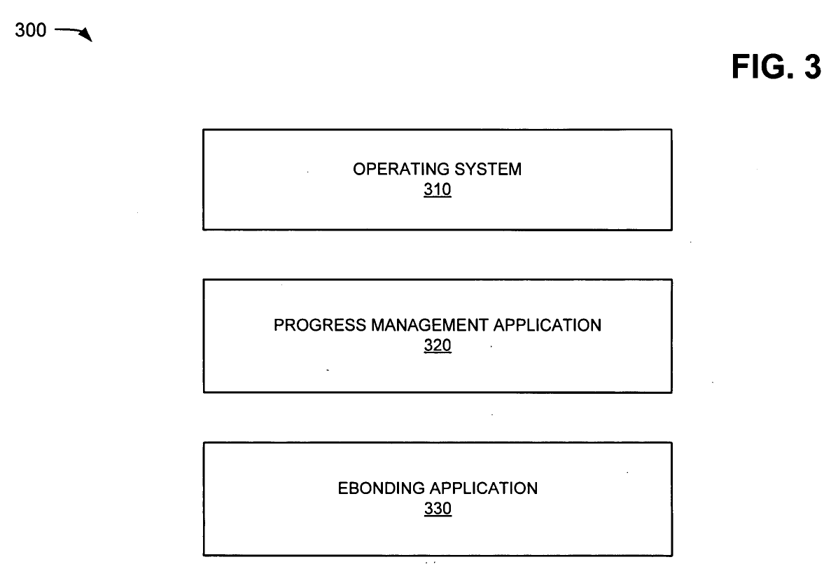

FIG. 3 depicts a diagram of a portion of an exemplary computer-readable medium 300 that may be used by user device 110, progress management server 120, and/or ebonding server 130. In one implementation, computer-readable medium 300 may correspond to main memory 230, ROM 240, and/or storage device 250 of device 200.

The portion of computer-readable medium 300 illustrated in FIG. 3 may include an operating system 310, a progress management application 320, and an ebonding application 330. Progress management application 320 and ebonding application 330 may be included in operating system 310 or may be separate from operating system 310. For example, in one implementation, progress management application 320 may be a process separate from operating system 310. In this implementation, progress management application 320 may be provided on a device (e.g., user device 110) that is separate from a device (e.g., progress management server 120) that includes operating system 310, but may interact with operating system 310 and ebonding application 330, e.g., via network 140.

Operating system 310 may include operating system software, such as the Microsoft Windows, Apple MAC OS, Linux, Unix, IBM OS/2, an operating system supporting multiple browser applications (e.g., Internet Explorer, Firefox, etc.), and/or other types of operating systems capable of use in server entities, user devices, or other types of computation or communication devices.

Progress management application 320 and ebonding application 330 may include an executable object or process. User device 110, progress management server 120, and/or ebonding server 130 may obtain the executable object or process from another device or from a disk, tape, network, CD-ROM, etc. Alternatively, the executable object or process may be pre-installed on user device 110, progress management server 120, and/or ebonding server 130. Progress management application 320 may perform any of the functions described herein as being performed by progress management server 120. Ebonding application 330 may perform any of the functions described herein as being performed by ebonding server 130. Progress management application 320 may be automatically activated upon initiation of operating system 310, and may interact with ebonding application 330 to automate task execution of a project. Alternatively, progress management application 320 may be activated when instructed by a user. In either case, progress management application 320 may receive milestone, task, and/or dependency information associated with a project, may generate a progress management model, a milestone flow chart, a task flow chart, project notifications, etc. based on the received information, as described herein.

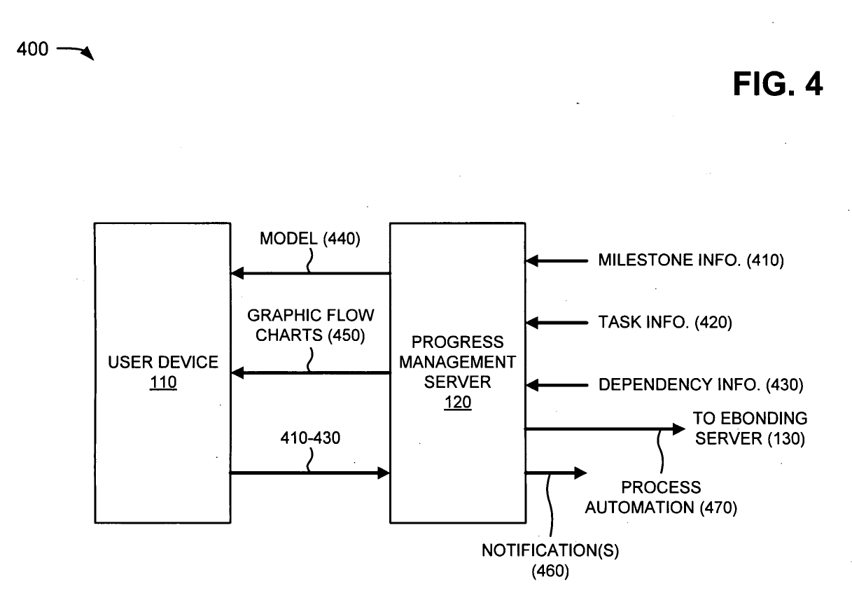

FIG. 4 illustrates a diagram of exemplary operations capable of being performed by an exemplary portion 400 of network 100. As illustrated, exemplary network portion 400 may include user device 110 and progress management server 120. User device 110 and progress management server 120 may include the features described above in connection with, for example, FIG. 1.

As further shown in FIG. 4, progress management server 120 may receive milestone information 410, task information 420, and/or dependency information 430 from a variety sources associated with a project (e.g., from user device(s) 110 associated with a project manager, a person performing project tasks, etc.). Milestone information 410 may include a baseline against which progress may be measured throughout the life of the project, one or more project tasks, milestone names, milestone owners, milestone states (e.g., incomplete, complete, in progress, etc.), planned durations for milestones, milestone start dates, milestone due dates, milestone end dates, etc. Task information 420 may include project tasks, task names, task owners, planned durations for tasks, task start dates, task due dates, task actual end dates, predecessor tasks, identities of persons completing tasks, etc. Dependency information 430 may include relationships between project milestones and/or tasks linked by dependencies between finish and start dates. For example, there may be four kinds of milestone/task dependencies: finish-to-start, start-to-start, finish-to-finish, and start-to-finish milestone/task dependencies. In one implementation, progress management server 120 may include a database (e.g., in storage device 250) that provides a central repository for storing project-related information (e.g., milestone information 410, task information 420, and/or dependency information 430).

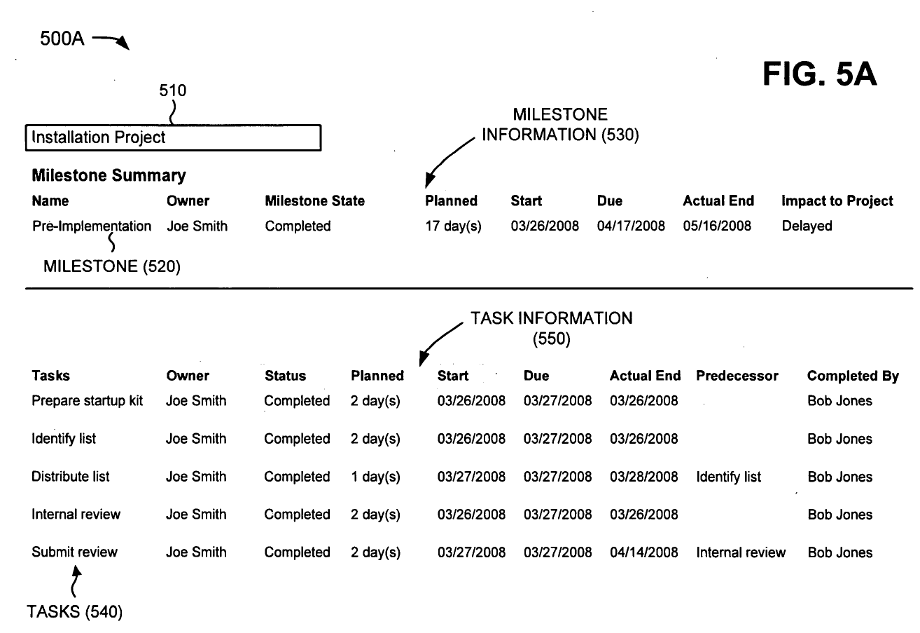

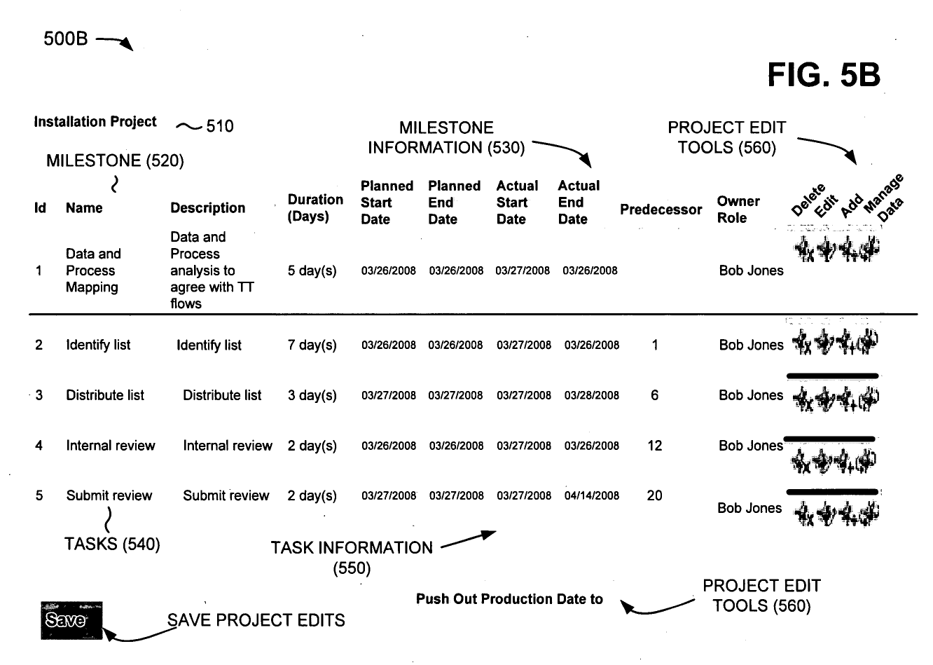

In one implementation, progress management server 120 may utilize milestone information 410, task information 420, and/or dependency information 430 to generate a model 440, graphic flow charts 450, notification(s) 460, and/or process automation 470. Progress management server 120 may provide model 440 and/or graphic flow charts 450 to user device 110 for display, and/or may display model 440 and/or graphic flow charts 450 (e.g., via output device 270). Model 440 may include a progress management model that provides a milestone summary, project tasks associated with milestones, information associated with the project tasks, etc. In one implementation, model 440 may capture each project with its milestones and/or tasks defined and projected via target completion dates, may drive workflow of the tasks, may support notifications (e.g., notification(s) 460), may support auto-completion of tasks if certain criteria are met (e.g., process automation 470), etc. Further details of model 440 are provided below in connection with, for example, FIG. 5.

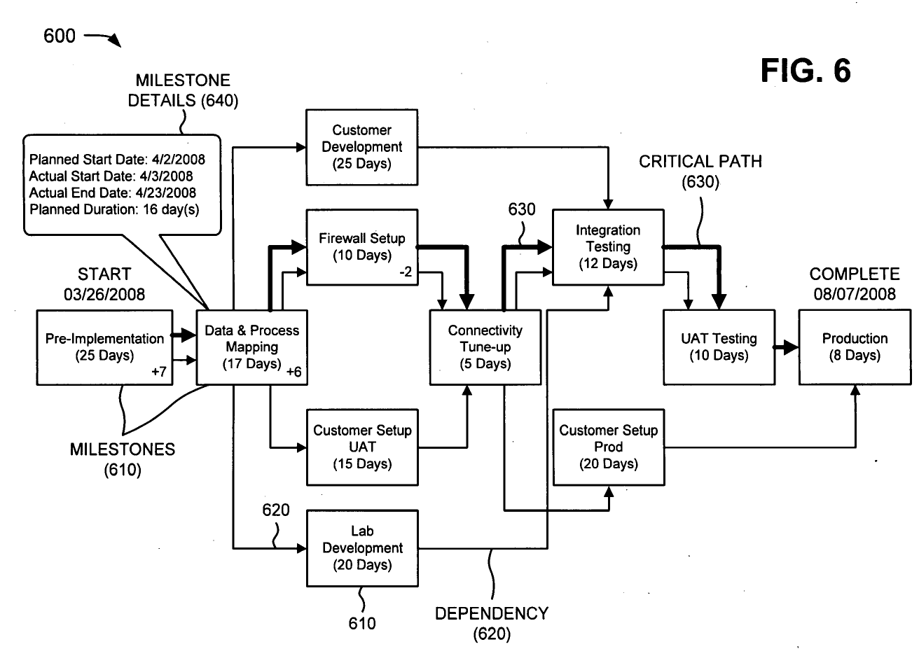

Graphic flow charts 450 may include one or more flow charts that provide intuitive, graphical representations of a flow associated with a project. In one implementation, graphic flow charts 450 may be dynamically generated (e.g., by progress management server 120) based on predefined templates, may include accurately drawn dependencies among tasks, may provide additional project information (e.g., project start and end dates, task start and end dates, duration, etc.), may provide a critical path associated with the project, may be supported by multiple browser applications, may be embedded into web pages, may be interactive, etc. In one exemplary implementation, graphic flow charts 450 may include milestone flow charts, task flow charts, etc. Further details of graphic flow charts 450 are provided below in connection with, for example, FIGS. 6-8.

Notifications 460 may include notifications associated with one or more milestones, one or more project tasks, etc. For example, notifications 460 may include visual, audible, or a combination of visual and audible warnings that may alert a user about a project (e.g., alert a user that completion of a task is past its due date). In one implementation, notifications 460 may be provided to the user in a variety of ways (e.g., via email, voicemail, instant messaging, text messaging, etc.).

Process automation 470 may include auto-completion of tasks if certain criteria are met. For example, process automation 470 may provide project tasks for auto-completion to ebonding server 130, and ebonding server 130 may automate execution of the project tasks.

Although FIG. 4 shows exemplary components of network portion 400, in other implementations, network portion 400 may contain fewer, different, or additional components than depicted in FIG. 4. In still other implementations, one or more components of network portion 400 may perform one or more other tasks described as being performed by one or more other components of network portion 400.

For example, although FIG. 4 shows progress management server 120 generating model 440, graphic flow charts 450, and notifications 460, in other implementations, features associated with progress management server 120 (e.g., including generation of model 440, graphic flow charts 450, and notifications 460) may be incorporated solely within user device 1 10. In such an arrangement, user device 110 may interact directly with a user (e.g., without involvement of progress management server 120), may receive milestone information 410, task information 420, and dependency information 430, and may generate model 440, graphic flow charts 450, and notifications 460 based on the received information 410-430.

FIGS. 5A and 5B depict diagrams of exemplary user interfaces 500A and 500B that are capable of being generated by user device 110 and/or progress management server 120. The user interfaces depicted in FIG. 5A and 5B, and each of the user interfaces depicted in FIGS. 6-8 and described below (collectively referred to as “the user interfaces”), may include a graphical user interface (GUI) or a non-graphical user interface, such as a text-based interface. The user interfaces may provide information to users via a customized interface (e.g., a proprietary interface) and/or other types of interfaces (e.g., a browser-based interface, a television interface, etc.). The user interfaces may receive user inputs via one or more input devices (e.g., input device 260), may be user-configurable (e.g., a user may change the size of the user interfaces, information displayed in the user interfaces, color schemes used by the user interfaces, positions of text, images, icons, windows, etc., in the user interfaces, etc.), and/or may not be user-configurable. The user interfaces may be displayed to a user via one or more output devices (e.g., output device 270).

As illustrated in FIG. 5A, user interface 500A may depict a progress management model (e.g., model 440) that may be generated by user device 110 and/or progress management server 120 (e.g., via progress management application 320). User interface 500A may include a variety of information associated with a project, such as a project name 510, a milestone 520, milestone information 530, tasks 540 associated with milestone 520, and task information 550. In one implementation, the information included in user interface 500 may be provided by milestone information 410, task information 420, and/or dependency information 430.

Project name 510 may include a name of a project associated with the model depicted by user interface 500. For example, the model may depict information associated with installation of a telecommunications network, and project name 510 may include a name (e.g., “Installation Project”) associated with the telecommunications network installation.

Milestone 520 may include a name of a milestone associated with the project provided by project name 510. For example, the “Installation Project” (e.g., provided by project name 510) may include a milestone 520 entitled “Pre-Implementation.” Milestone 520 may be provided in a milestone summary section that includes milestone information 530. As shown in FIG. 5, the milestone summary section may include a milestone name field (e.g., “Pre-Implementation”), a milestone owner field (e.g., “Joe Smith”), a milestone state field (e.g., “Completed”), a planned milestone duration field (e.g., “17 day(s)”), a milestone start date field (e.g., “03/26/2008”), a milestone due date field (e.g., “04/17/2008”), a milestone actual end date field (e.g., “05/16/2008”), and a milestone impact to project field (e.g., “Delayed”). In one implementation, milestone information 530 may correspond to milestone information 410 received by progress management server 120.

Tasks 540 may include one or more tasks associated with milestone 520. For example, milestone 520 may include tasks 540, such as “Prepare startup kit,” “Identify list,” “Distribute list,” “Internal review,” and “Submit review.”

Task information 550 may include a variety of information associated with tasks 540. For example, as shown in FIG. 5, task information 550 may include a tasks field (e.g., that provides tasks 540), a task owner field (e.g., “Joe Smith”), a task status field (e.g., “Completed”), a task planned duration field (e.g., “2 day(s)”), a task start date field (e.g., “03/26/2008”), a task due date field (e.g., “03/27/2008”), a task actual end date field (e.g., “03/26/2008”), a task predecessor field (e.g., that provides a name of a predecessor task, such as “Identify list”), and a task completed by field (e.g., “Bob Jones”). In one implementation, task information 550 may correspond to task information 420 and/or dependency information 430 received by progress management server 120.

As shown in FIG. 5B, user interface 500B may depict a revised progress management model (e.g., model 440), which is different from the original progress management model depicted in FIG. 5A. In one implementation, user interface 500B may be generated by progress management server 120 based on its interactions with ebonding server 130. User interface 500B may include project name 510, milestone 520, milestone information 530, tasks 540 associated with milestone 520, and task information 550. Project name 510, milestone 520, milestone information 530, tasks 540 associated with milestone 520, and task information 550 may include the features described above in connection with FIG. 5A.

As further shown in FIG. 5B, user interface 500B may permit a user to modify the progress management model via project edit tools 560. In one implementation, project edit tools 560 may permit the user to add, edit, delete, and/or manage data fields associated with task 540 and milestone 520. The user may save the project edits by selecting a “Save” mechanism. Project edit tools 560 may accurately reset the progress management model per predefined templates, which may include accurately drawn dependencies among tasks, additional project information (e.g., project start and end dates, task start and end dates, duration, etc.), and a critical path associated with the project. Project edit tools 560 may output a revised set of milestone information 530 and task information 550, which may result in a dynamic and new critical path associated with the project. Further, project edit tools 560 may provide a “Push Out Production Date” feature that enables the user to extend a production date of the project to a later date. This may result in a new progress management model (e.g., with a revised set of milestone information 530 and task information 550), and the impact of the new progress management model may be reflected in the graphical flow charts (e.g., as shown in FIGS. 6-8) in terms of timelines and/or workflow.

Although user interfaces 500A and 500B depicts a variety of information, in other implementations, user interfaces 500A and 500B may depict less, additional, different, or differently arranged information than depicted in FIGS. 5A and 5B. For example, user interface 500A may include additional milestones and may include one or more tasks (e.g., tasks 540) associated with each of the additional milestones.

FIG. 6 illustrates a diagram of an exemplary user interface 600 that is capable of being generated by user device 110 and/or progress management server 120 (e.g., via progress management application 320). As illustrated in FIG. 6, user interface 600 may depict a graphic flow chart (e.g., one of graphic flow charts 450) of milestones associated with a project. The milestone graphic flow chart may be generated based on the progress management model depicted in FIG. 5. In an exemplary implementation, progress management server 120 may utilize one or more dynamically defined templates (e.g., extensible markup language (XML) templates) that include sequences of milestones, tasks, and/or dependencies, and may convert the one or more templates into the milestone graphic flow chart depicted in FIG. 6. In one example, progress management server 120 may generate the milestone graphic flow chart using JavaScript and dynamic hypertext markup language (DHTML), and may display the milestone graphic flow chart via a web-based user interface. The milestone graphic flow chart may support multiple browser applications, and may be embedded into web pages.

As shown in FIG. 6, user interface 600 may include one or more milestones 610 associated with a project, one or more dependencies 620 between milestones 610, a critical path 630 associated with milestones 610, and milestone details 640. In one example, the project associated with the information depicted in FIG. 6 may include a telecommunications network installation project.

Milestones 610 may include names of milestones associated with the project and representations (e.g., rectangular nodes) of the milestones associated with the project. In one implementation, user device 110 and/or progress management server 120 may automatically create milestones 610 based on milestone information 410. As shown in FIG. 6, milestones 610 may include a “Pre-implementation” milestone, a “Data & Process Mapping” milestone, a “Customer Development” milestone, a “Firewall Setup” milestone, a “Customer Setup User Acceptance Testing (UAT)” milestone, a “Lab Development” milestone, a “Connectivity Tune-up” milestone, an “Integration Testing” milestone, a “Customer Setup Product (Prod)” milestone, a “UAT Testing” milestone, and a “Production” milestone. In one exemplary implementation, milestones 610 may be shaped, colored, highlighted, distinguished, etc. in different ways to represent status information associated with milestones 610 (e.g., a red milestone 610 (not shown) may indicate that the milestone is behind schedule, a green milestone 610 (not shown) may indicate that the milestone is complete, etc.).

Dependencies 620 may include dependencies among one or more milestones 610, and may be represented by arrows (e.g., directed arcs) provided between milestones 610. In one implementation, user device 110 and/or progress management server 120 may automatically generate dependencies 620 based on milestone information 410 and dependency information 430. As shown in FIG. 6, the “Data & Process Mapping” milestone may depend on the “Pre-implementation” milestone; the “Customer Development,” “Firewall Setup,” “Customer Setup UAT,” and “Lab Development” milestones may depend on the “Data & Process Mapping” milestone; the “Connectivity Tune-up” milestone may depend on the “Customer Setup UAT” and “Lab Development” milestones; the “Integration Testing” milestone may depend on the “Customer Development,” “Lab Development,” and “Connectivity Tune-up” milestones; the “Customer Setup (Prod)” milestone may depend on the “Connectivity Tune-up” milestone; the “UAT Testing” milestone may depend on the “Integration Testing” milestone; and the “Production” milestone may depend on the “UAT Testing” and “Customer Setup (Prod)” milestones.

Critical path 630 may include a path that defines a sequence of milestones 610 that add up to a longest overall duration. Critical path 630 may determine a shortest time possible to complete the project. In one implementation, critical path 630 may be highlighted (e.g., via colored directed arcs, bolded directed arcs, colored and bolded directed arcs, etc.) to distinguish critical path 630 from dependencies 620. User device 110 and/or progress management server 120 may automatically calculate and/or generate critical path 630 based on milestone information 410 and dependency information 430, and may dynamically change or update critical path 630 based on progress associated with milestones 610. As shown in FIG. 6, critical path 630 may interconnect the “Pre-implementation,” “Data & Process Mapping,” “Firewall Setup,” “Connectivity Tune-up,” “Integration Testing,” “UAT Testing,” and “Production” milestones to show that these milestones define critical path 630.

In one implementation, user interface 600 may be interactive. For example, if a user performs a “mouseover” operation on one of milestones 610 (e.g., points to one of milestones 610 with a pointing device, but does not select the milestone), user interface 600 may display a portion of milestone details 640. The portion of milestone details 640 may include less than all of the information associated with the selected one of milestones 610. For example, the portion of milestone details 640 may include a start date, an end date, and a duration associated with the selected one of milestones 610. If the user selects one of milestones 610 (e.g., via a pointing device), user interface 600 may display an entirety of milestone details 640. The entirety of milestone details 640 may include all of the information associated with the selected one of milestones 610. For example, the entirety of milestone details 640 may include a name, an owner, a state, a planned duration, a start date, a due date, an actual end date, and an impact associated with the selected one of milestones 610.

In one exemplary implementation, user interface 600 may depict additional information associated with the project. For example, as further shown in FIG. 6, user interface 600 may include a start date (e.g., “03/26/2008”) and an end date (e.g., “08/07/2008”) associated with the project.

Although user interface 600 depicts a variety of information, in other implementations, user interface 600 may depict less, additional, different, or differently arranged information than depicted in FIG. 6. For example, user interface 600 may provide an impact analysis with one or more of milestones 610. Each impact analysis may provide consequences (e.g., to completion of the project) associated with a change (e.g., a change in end date, a delay in completion, etc.) to one of milestones 610.

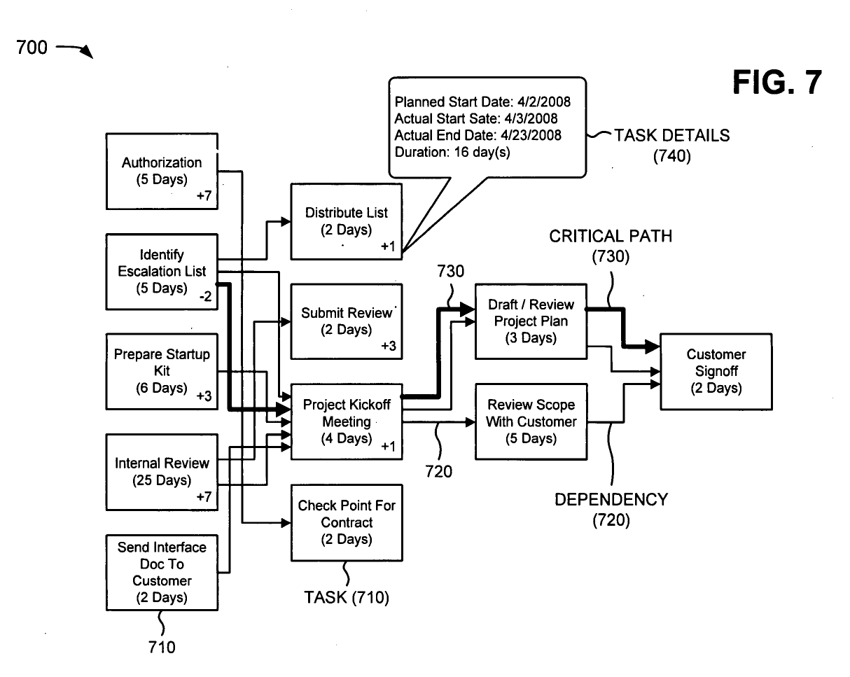

FIG. 7 depicts a diagram of exemplary user interface 700 that is capable of being generated by user device 110 and/or progress management server 120 (e.g., via progress management application 320). As illustrated in FIG. 7, user interface 700 may depict a graphic flow chart (e.g., one of graphic flow charts 450) of tasks associated with a milestone. The task graphic flow chart may be generated based on the progress management model depicted in FIG. 5. In an exemplary implementation, progress management server 120 may utilize one or more dynamically defined templates (e.g., XML templates) that include sequences of milestones, tasks, and/or dependencies, and may convert the one or more templates into the task graphic flow chart depicted in FIG. 7. In one example, progress management server 120 may generate the task graphic flow chart using JavaScript and DHTML, and may display the task graphic flow chart via a web-based user interface. The task graphic flow chart may support multiple browser applications, and may be embedded into web pages.

As shown in FIG. 7, user interface 700 may include one or more tasks 710 associated with a milestone, one or more dependencies 720 between tasks 710, a critical path 730 associated with tasks 710, and task details 740. In one example, the milestone associated with the information depicted in FIG. 7 may include the “Pre-implementation” milestone shown in FIG. 6.

Tasks 710 may include names of tasks associated with the milestone and representations (e.g., rectangular nodes) of the tasks associated with the milestone. In one implementation, user device 110 and/or progress management server 120 may automatically create tasks 710 based on task information 420. As shown in FIG. 7, tasks 710 may include an “Authorization” task, an “Identify Escalation List” task, a “Prepare Startup Kit” task, an “Internal Review” task, a “Send Interface Doc To Customer” task, a “Distribute List” task, a “Submit Review” task, a “Project Kickoff Meeting” task, a “Check Point For Contract” task, a “Draft/Review Project Plan” task, a “Review Scope With Customer” task, and a “Customer Signoff” task. In one exemplary implementation, tasks 710 may be shaped, colored, highlighted, distinguished, etc. in different ways to represent status information associated with tasks 710 (e.g., a red task 710 (not shown) may indicate that the task is behind schedule, a green task 710 (not shown) may indicate that the task is complete, etc.).

Dependencies 720 may include dependencies among one or more tasks 710, and may be represented by arrows (e.g., directed arcs) provided between tasks 710. In one implementation, user device 110 and/or progress management server 120 may automatically generate dependencies 720 based on task information 420 and dependency information 430. As shown in FIG. 7, the “Distribute List” task may depend on the “Identify Escalation List” task; the “Submit Review” task may depend on the “Internal Review” task; the “Project Kickoff Meeting” task may depend on the “Identify Escalation List,” “Prepare Startup Kit,” “Internal Review,” and “Send Interface Doc To Customer” tasks; the “Check Point For Contract” task may depend on the “Authorization” task; the “Draft/Review Project Plan” and “Review Scope With Customer” tasks may depend on the “Project Kickoff Meeting” task; and the “Customer Signoff” task may depend on the “Draft/Review Project Plan” and “Review Scope With Customer” tasks.

Critical path 730 may include a path that defines a sequence of tasks 710 that add up to a longest overall duration. Critical path 730 may determine a shortest time possible to complete the milestone. In one implementation, critical path 730 may be highlighted (e.g., via colored directed arcs, bolded directed arcs, colored and bolded directed arcs, etc.) to distinguish critical path 730 from dependencies 720. User device 110 and/or progress management server 120 may automatically calculate and/or generate critical path 730 based on task information 420 and dependency information 430, and may dynamically change or update critical path 730 based on progress associated with tasks 710. As shown in FIG. 7, critical path 730 may interconnect the “Identify Escalation List,” “Project Kickoff Meeting,” “Draft/Review Project Plan,” and “Customer Signoff” tasks to show that these tasks define critical path 730.

In one implementation, user interface 700 may be interactive. For example, if a user performs a “mouseover” operation on one of tasks 710 (e.g., points to one of tasks 710 with a pointing device, but does not select the task), user interface 700 may display a portion of task details 740. The portion of task details 740 may include less than all of the information associated with the selected one of tasks 710. For example, the portion of task details 740 may include a start date, an end date, and a duration associated with the selected one of tasks 710. If the user selects one of tasks 710 (e.g., via a pointing device), user interface 700 may display an entirety of task details 740. The entirety of task details 740 may include all of the information associated with the selected one of tasks 710. For example, the entirety of task details 740 may include a name, an owner, a status, a planned duration, a start date, a due date, an actual end date, a predecessor task, and a worker associated with the selected one of tasks 710.

Although user interface 700 depicts a variety of information, in other implementations, user interface 700 may depict less, additional, different, or differently arranged information than depicted in FIG. 7. For example, user interface 700 may provide an impact analysis with one or more of tasks 710. Each impact analysis may provide consequences (e.g., to completion of the milestone and/or project) associated with a change (e.g., a change in end date, a delay in completion, etc.) to one of tasks 710.

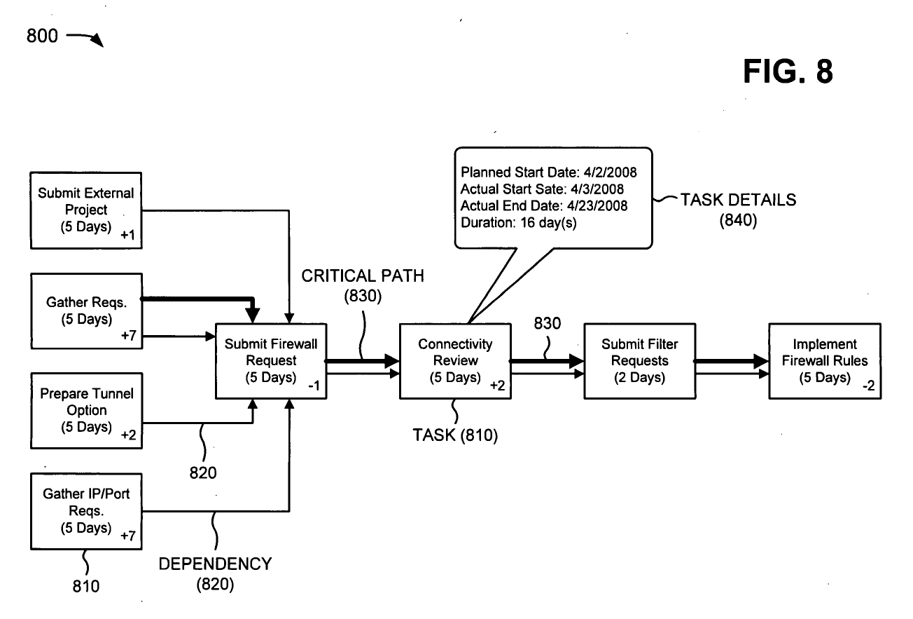

FIG. 8 illustrates a diagram of exemplary user interface 800 that is capable of being generated by user device 110 and/or progress management server 120 (e.g., via progress management application 320). As illustrated in FIG. 8, user interface 800 may depict a graphic flow chart of tasks associated with a milestone. The task graphic flow chart may be generated based on the progress management model depicted in FIG. 5. In an exemplary implementation, progress management server 120 may utilize one or more dynamically defined templates (e.g., XML templates) that include sequences of milestones, tasks, and/or dependencies, and may convert the one or more templates into the task graphic flow chart depicted in FIG. 8. In one example, progress management server 120 may generate the task graphic flow chart using JavaScript and DHTML, and may display the task graphic flow chart via a web-based user interface. The task graphic flow chart may support multiple browser applications, and may be embedded into web pages.

As shown in FIG. 8, user interface 800 may include one or more tasks 810 associated with a milestone, one or more dependencies 820 between tasks 810, a critical path 830 associated with tasks 810, and task details 840. In one example, the milestone associated with the information depicted in FIG. 8 may include the “Firewall Setup” milestone shown in FIG. 6.

Tasks 810 may include names of tasks associated with the milestone and representations (e.g., rectangular nodes) of the tasks associated with the milestone. In one implementation, user device 110 and/or progress management server 120 may automatically create tasks 810 based on task information 420. As shown in FIG. 8, tasks 810 may include a “Submit External Project” task, a “Gather Requirements” task, a “Prepare Tunnel Option” task, a “Gather IP/Port Requirements” task, a “Submit Firewall Request” task, a “Connectivity Review” task, a “Submit Filter Requests” task, and an “Implement Firewall Rules” task. In one exemplary implementation, tasks 810 may be shaped, colored, highlighted, distinguished, etc. in different ways to represent status information associated with tasks 810 (e.g., an oval shaped task 810 (not shown) may indicate that the task is behind schedule, a square shaped task 810 (not shown) may indicate that the task is complete, etc.).

Dependencies 820 may include dependencies among one or more tasks 810, and may be represented by arrows (e.g., directed arcs) provided between tasks 810. In one implementation, user device 110 and/or progress management server 120 may automatically generate dependencies 820 based on task information 420 and dependency information 430. As shown in FIG. 8, the “Submit Firewall Request” task may depend on the “Submit External Project,” “Gather Requirements,” “Prepare Tunnel Option,” and “Gather IP/Port Requirements” tasks; the “Connectivity Review” task may depend on the “Submit Firewall Request” task; the “Submit Filter Requests” task may depend on the “Connectivity Review” tasks; and the “Implement Firewall Rules” task may depend on the “Submit Filter Requests” task.

Critical path 830 may include a path that defines a sequence of tasks 810 that add up to a longest overall duration. Critical path 830 may determine a shortest time possible to complete the milestone. In one implementation, critical path 830 may be highlighted (e.g., via colored directed arcs, bolded directed arcs, colored and bolded directed arcs, etc.) to distinguish critical path 830 from dependencies 820. User device 110 and/or progress management server 120 may automatically calculate and/or generate critical path 830 based on task information 420 and dependency information 430, and may dynamically change or update critical path 830 based on progress associated with tasks 810. As shown in FIG. 8, critical path 830 may interconnect the “Gather Requirements,” “Submit Firewall Request,” “Connectivity Review,” “Submit Filter Requests,” and “Implement Firewall Rules” tasks to show that these tasks define critical path 830.

In one implementation, user interface 800 may be interactive. For example, if a user performs a “mouseover” operation on one of tasks 810 (e.g., points to one of tasks 810 with a pointing device, but does not select the task), user interface 800 may display a portion of task details 840. The portion of task details 840 may include less than all of the information associated with the selected one of tasks 810. For example, the portion of task details 840 may include a start date, an end date, and a duration associated with the selected one of tasks 810. If the user selects one of tasks 810 (e.g., via a pointing device), user interface 800 may display an entirety of task details 840. The entirety of task details 840 may include all of the information associated with the selected one of tasks 810. For example, the entirety of task details 840 may include a name, an owner, a status, a planned duration, a start date, a due date, an actual end date, a predecessor task, and a worker associated with the selected one of tasks 810.

Although user interface 800 depicts a variety of information, in other implementations, user interface 800 may depict less, additional, different, or differently arranged information than depicted in FIG. 8. For example, user interface 800 may provide an impact analysis with one or more of tasks 810. Each impact analysis may provide consequences (e.g., to completion of the milestone and/or project) associated with a change (e.g., a change in end date, a delay in completion, etc.) to one of tasks 810.

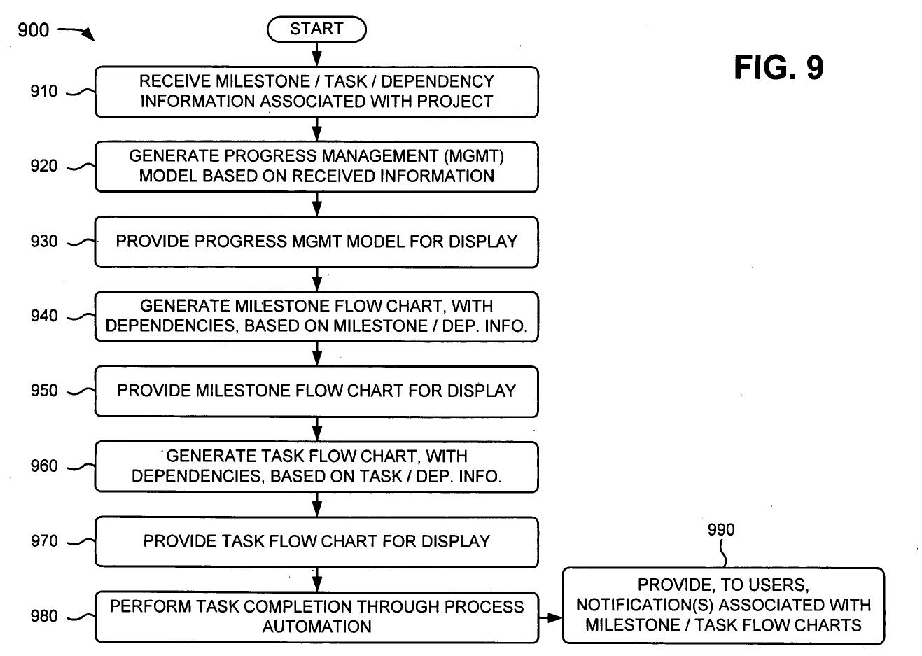

FIGS. 9-12 illustrate a flow chart of an exemplary process 900 for creating a progress management model and interactive project flow charts according to implementations described herein. In one implementation, process 900 may be performed by progress management server 120. In another implementation, some or all of process 900 may be performed by another device (e.g., user device 110 and/or ebonding server 130) or group of devices, including or excluding progress management server 120.

As illustrated in FIG. 9, process 900 may begin with receipt of milestone, task, and/or dependency information associated with a project (block 910), generation of a progress management model based on the received information (block 920), and providing the progress management model for display (block 930). For example, in implementations described above in connection with FIG. 4, progress management server 120 may receive milestone information 410, task information 420, and/or dependency information 430 from a variety sources associated with a project. Progress management server 120 may utilize milestone information 410, task information 420, and/or dependency information 430 to generate model 440. Model 440 may include a progress management model that provides a milestone summary, project tasks associated with milestones, information associated with the project tasks, etc. Progress management server 120 may provide model 440 to user device 110 for display, and/or may display model 440.

As further shown in FIG. 9, a milestone flow chart, with dependencies, may be generated based on the milestone information and the dependency information (block 940), and the milestone flow chart may be provided for display (block 950). For example, in implementations described above in connection with FIGS. 4 and 6, progress management server 120 may utilize milestone information 410, task information 420, and/or dependency information 430 to generate graphic flow charts 450. Graphic flow charts 450 may include the milestone flow chart depicted by user interface 600. User interface 600 may include milestones 610 associated with a project, and dependencies 620 between milestones 610. Progress management server 120 may provide graphic flow charts 450 to user device 110 for display and/or may display graphic flow charts 450 (e.g., as user interface 600).

Returning to FIG. 9, a task flow chart, with dependencies, may be generated based on task information and/or dependency information (block 960), the task flow chart may be provided for display (block 970), and task completion may be performed through process automation (block 980). For example, in implementations described above in connection with FIGS. 4 and 7, progress management server 120 may utilize milestone information 410, task information 420, and/or dependency information 430 to generate graphic flow charts 450. Graphic flow charts 450 may include the task flow chart depicted by user interface 700. User interface 700 may include tasks 710 associated with a milestone, and dependencies 720 between tasks 710. Progress management server 120 may provide graphic flow charts 450 to user device 110 for display and/or may display graphic flow charts 450 (e.g., as user interface 700). In one example, progress management server 120 may utilize milestone information 410, task information 420, and/or dependency information 430 to automatically execute a task by integrating with a backend application and following prebuilt logic, without any inputs from the user. The completion of such an automated task may be displayed in graphic flow charts 450 (e.g., as task 710).

As further shown in FIG. 9, one or more notifications associated with the milestone and/or task flow charts may be provided to users (block 990). For example, in implementations described above in connection with FIG. 4, progress management server 120 may utilize milestone information 410, task information 420, and/or dependency information 430 to generate notifications 460. Notifications 460 may include notifications associated with one or more milestones, one or more project tasks, etc. In one example, notifications 460 may include visual, audible, or a combination of visual and audible warnings that may alert a user about a project (e.g., alert a user that completion of a task is past its due date). In another example, notifications 460 may be provided to the user in a variety of ways (e.g., via email, voicemail, instant messaging, text messaging, etc.).

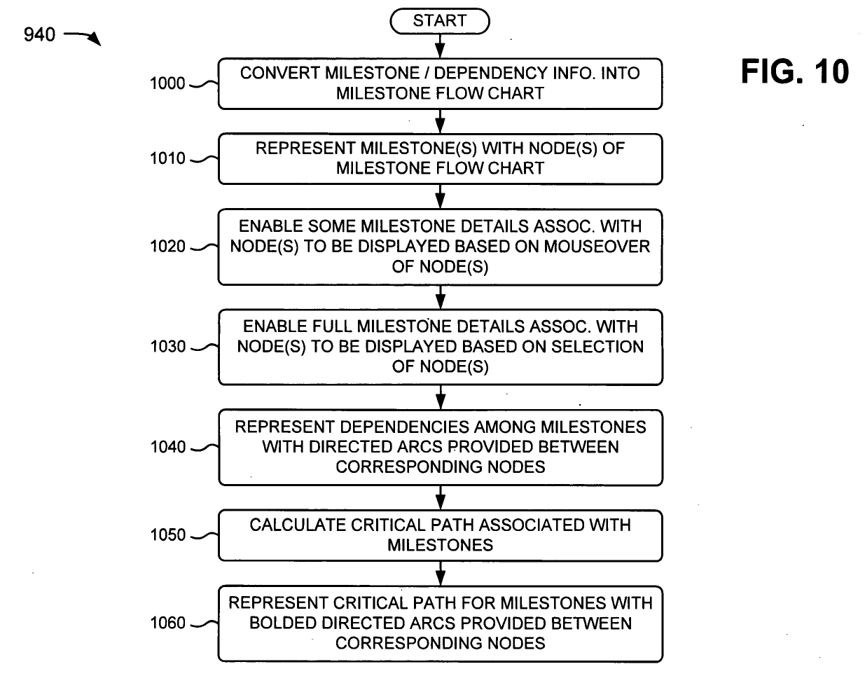

Process block 940 may include the process blocks depicted in FIG. 10. As shown in FIG. 10, process block 940 may include converting milestone information and dependency information into the milestone flow chart (block 1000), and representing one or more milestones with one or more nodes of the milestone flow chart (block 1010). For example, in implementations described above in connection with FIG. 6, progress management server 120 may utilize one or more dynamically defined templates (e.g., XML templates) that include sequences of milestones (e.g., milestone information 410), tasks (e.g., task information 420), and/or dependencies (e.g., dependency information 430), and may convert the one or more templates into the milestone flow chart depicted by user interface 600. User interface 600 may include milestones 610 associated with a project. Milestones 610 may include names of milestones associated with the project and representations (e.g., rectangular nodes) of the milestones associated with the project.

As further shown in FIG. 10, process block 940 may include enabling some milestone details associated with the one or more nodes to be displayed based on a mouseover of the one or more nodes (block 1020), and enabling full milestone details associated with the one or more nodes to be displayed based on selection of the one or more nodes (block 1030). For example, in implementations described above in connection with FIG. 6, user interface 600 may include milestone details 640. If a user performs a “mouseover” operation on one of milestones 610 (e.g., points to one of milestones 610 with a pointing device, but does not select the milestone), user interface 600 may display a portion of milestone details 640. The portion of milestone details 640 may include less than all of the information associated with the selected one of milestones 610. If the user selects one of milestones 610 (e.g., via a pointing device), user interface 600 may display an entirety of milestone details 640. The entirety of milestone details 640 may include all of the information associated with the selected one of milestones 610.

Returning to FIG. 10, process block 940 may include representing dependencies among milestones with directed arcs provided between corresponding nodes (block 1040), calculating a critical path associated with the milestones (block 1050), and representing the critical path for the milestones with bolded directed arcs provided between corresponding nodes (block 1060). For example, in implementations described above in connection with FIG. 6, user interface 600 may include one or more dependencies 620 between milestones 610 and critical path 630 associated with milestones 610. Dependencies 620 may be represented by arrows (e.g., directed arcs) provided between milestones 610. In one example, user device 110 and/or progress management server 120 may automatically generate dependencies 620 based on milestone information 410 and dependency information 430. Critical path 630 may include a path that defines a sequence of milestones 610 that add up to a longest overall duration. In one example, critical path 630 may be highlighted (e.g., via colored directed arcs, bolded directed arcs, colored and bolded directed arcs, etc.) to distinguish critical path 630 from dependencies 620. User device 110 and/or progress management server 120 may automatically calculate critical path 630 based on milestone information 410 and dependency information 430, and may dynamically change or update critical path 630 based on progress associated with milestones 610.

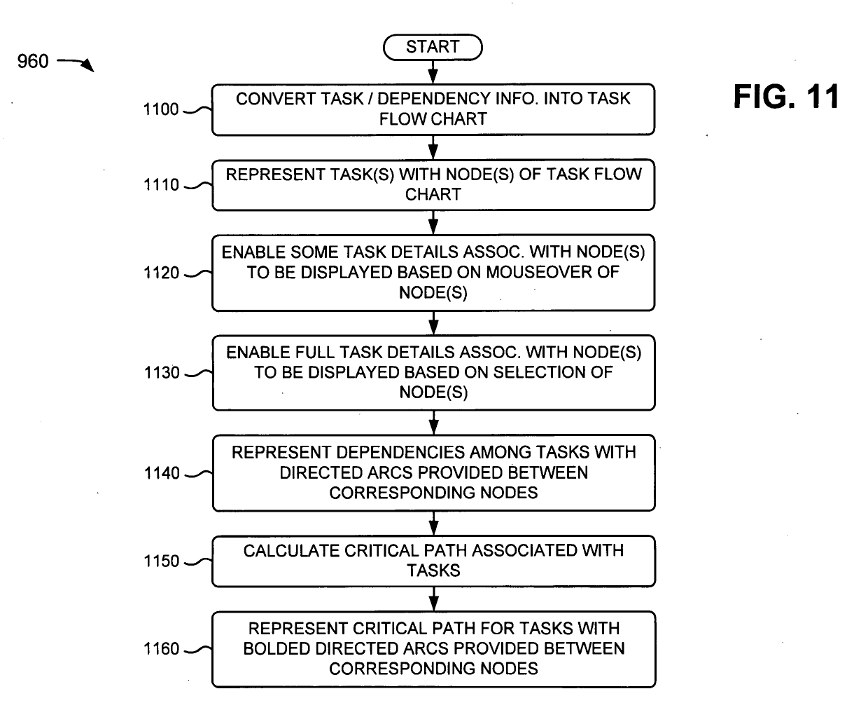

Process block 960 may include the process blocks depicted in FIG. 11. As shown in FIG. 11, process block 960 may include converting task information and dependency information into the task flow chart (block 1100), and representing one or more tasks with one or more nodes of the task flow chart (block 1110). For example, in implementations described above in connection with FIG. 7, progress management server 120 may utilize one or more dynamically defined templates (e.g., XML templates) that include sequences of milestones (e.g., milestone information 410), tasks (e.g., task information 420), and/or dependencies (e.g., dependency information 430), and may convert the one or more templates into the task flow chart depicted by user interface 700. User interface 700 may include tasks 710 associated with a milestone. Tasks 710 may include names of tasks associated with the milestone and representations (e.g., rectangular nodes) of the tasks associated with the milestone.

As further shown in FIG. 11, process block 960 may include enabling some task details associated with the one or more nodes to be displayed based on a mouseover of the one or more nodes (block 1120), and enabling full task details associated with the one or more nodes to be displayed based on selection of the one or more nodes (block 1130). For example, in implementations described above in connection with FIG. 7, user interface 700 may include task details 740. If a user performs a “mouseover” operation on one of tasks 710 (e.g., points to one of tasks 710 with a pointing device, but does not select the milestone), user interface 700 may display a portion of task details 740. The portion of task details 740 may include less than all of the information associated with the selected one of tasks 710. If the user selects one of tasks 710 (e.g., via a pointing device), user interface 700 may display an entirety of task details 740. The entirety of task details 740 may include all of the information associated with the selected one of tasks 710.

Returning to FIG. 11, process block 960 may include representing dependencies among tasks with directed arcs provided between corresponding nodes (block 1140), calculating a critical path associated with the tasks (block 1150), and representing the critical path for the tasks with bolded directed arcs provided between corresponding nodes (block 1160). For example, in implementations described above in connection with FIG. 7, user interface 700 may include one or more dependencies 720 between tasks 710 and critical path 730 associated with tasks 710. Dependencies 720 may be represented by arrows (e.g., directed arcs) provided between tasks 710. In one example, user device 110 and/or progress management server 120 may automatically generate dependencies 720 based on task information 420 and dependency information 430. Critical path 730 may include a path that defines a sequence of tasks 710 that add up to a longest overall duration. In one example, critical path 730 may be highlighted (e.g., via colored directed arcs, bolded directed arcs, colored and bolded directed arcs, etc.) to distinguish critical path 730 from dependencies 720. User device 110 and/or progress management server 120 may automatically calculate critical path 730 based on task information 420 and dependency information 430, and may dynamically change or update critical path 730 based on progress associated with tasks 710.

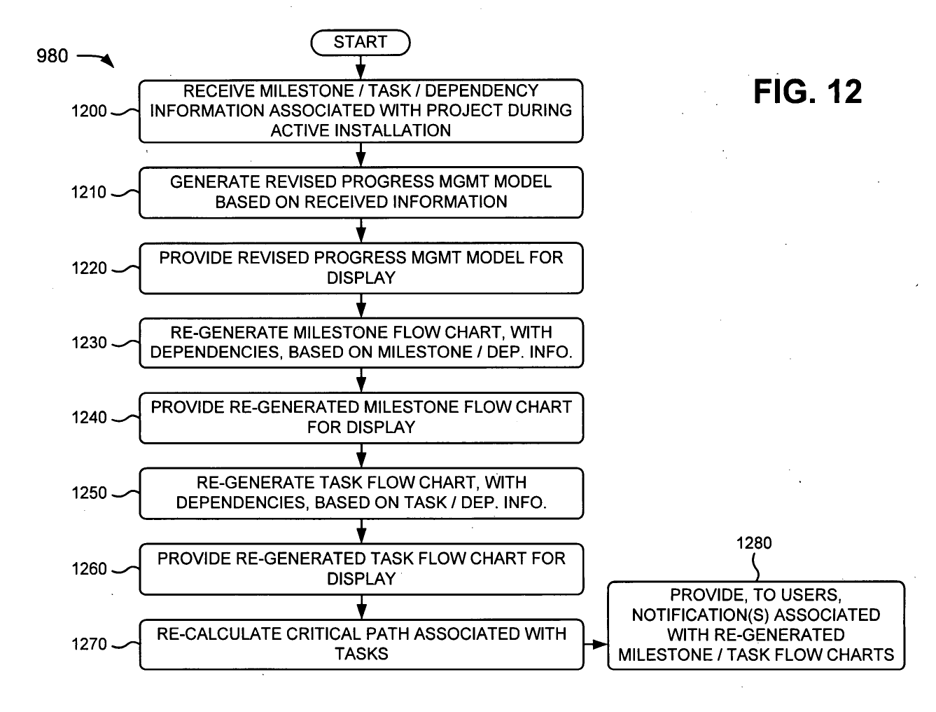

Process block 980 may include the process blocks depicted in FIG. 12. As shown in FIG. 12, process block 980 may include receiving milestone, task, and/or dependency information associated with a project during its active installation (block 1200), generating of a revised progress management model based on the received information (1210), and providing the revised progress management model for display (block 1220). For example, in implementations described above in connection with FIG. 5B, user interface 500B may permit a user to modify the progress management model via project edit tools 560. Project edit tools 560 may permit the user to add, edit, delete, and/or manage data fields associated with task 540 and milestone 520.

As further shown in FIG. 12, process block 980 may include re-generating the milestone flow chart, with dependencies, based on the milestone and dependency information (block 1230), providing the re-generated milestone flow chart for display (block 1240), re-generating the task flow chart, with dependencies, based on the task and dependency information (block 1250), providing the re-generated task flow chart for display (block 1260). For example, in implementations described above in connection with FIG. 5B, project edit tools 560 may accurately reset the progress management model per predefined templates, which may include accurately drawn dependencies among tasks, and additional project information (e.g., project start and end dates, task start and end dates, duration, etc.). Project edit tools 560 may provide a “Push Out Production Date” feature that enables the user to extend a production date of the project to a later date. This may result in a new progress management model (e.g., with a revised set of milestone information 530 and task information 550), and the impact of the new progress management model may be reflected in the graphical flow charts (e.g., as shown in FIGS. 6-8) in terms of timelines and/or workflow.

Returning FIG. 12, process block 980 may include re-calculating the critical path associated with the tasks (block 1270), and regenerating the notifications associated with the milestone and task flow charts (block 1280). For example, in implementations described above in connection with FIG. 5B, project edit tools 560 may accurately reset the progress management model per predefined templates, which may include a critical path associated with the project. Project edit tools 560 may output a revised set of milestone information 530 and task information 550, which may result in a dynamic and new critical path associated with the project and re-generation of notifications 460.

Systems and/or methods described herein may provide a progress management platform that creates a progress management model based on milestones, tasks, and/or dependencies associated with a project, and that creates intuitive and interactive project flow charts that include dependencies and critical paths among tasks. In one implementation, for example, the systems and/or methods may receive milestone, task, and/or dependency information associated with a project, may generate a progress management model based on the received information, and may provide the progress management model for display. The systems and/or methods may generate a milestone flow chart, with dependencies among milestones, based on the milestone information and associated dependency information, and may provide the milestone flow chart for display. The systems and/or methods may generate a task flow chart, with dependencies among tasks, based on the task information and associated dependency information, may provide the task flow chart for display, and may provide, to one or more users, one or more notifications associated the milestone and task flow charts.

The foregoing description of implementations provides illustration and description, but is not intended to be exhaustive or to limit the invention to the precise form disclosed. Modifications and variations are possible in light of the above teachings or may be acquired from practice of the invention.

For example, while a series of blocks has been described with regard to FIGS. 9-11, the order of the blocks may be modified in other implementations. Further, non-dependent blocks may be performed in parallel.

It will be apparent that embodiments, as described herein, may be implemented in many different forms of software, firmware, and hardware in the implementations illustrated in the figures. The actual software code or specialized control hardware used to implement embodiments described herein is not limiting of the invention. Thus, the operation and behavior of the embodiments were described without reference to the specific software code—it being understood that software and control hardware may be designed to implement the embodiments based on the description herein.

Further, certain portions of the invention may be implemented as “logic” that performs one or more functions. This logic may include hardware, such as an application specific integrated circuit or a field programmable gate array, or a combination of hardware and software.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A computing device-implemented method, comprising:
receiving milestone information and dependency information associated with a project;
generating a milestone flow chart based on the milestone information and the dependency information;
representing one or more milestones, in the milestone flow chart, with one or more nodes;
representing one or more dependencies among the one or more milestones with one or more directed arcs provided between corresponding nodes of the one or more nodes;
calculating a critical path associated with the one or more milestones;
representing the critical path with bolded directed arcs provided between corresponding nodes of the one or more nodes; and
providing the milestone flow chart, including the representations of the one or more milestones, the one or more dependencies, and the critical path, for display.

2. The computing device-implemented method of claim 1, further comprising:
storing the milestone information and the dependency information in one or more templates, as sequences of milestones and milestone dependencies; and
converting the one or more templates into the milestone flow chart.

3. The computing device-implemented method of claim 2, where each of the one or more templates comprises an extensible markup language (XML) template.

4. The computing device-implemented method of claim 1, where the milestone flow chart is provided for display via a web-based user interface, and where the milestone flow chart supports multiple browser applications.

5. The computing device-implemented method of claim 1, further comprising one of:
enabling some milestone details associated with a particular node of the one or more nodes to be displayed when a mouseover operation is performed on the particular node of the one or more nodes; or
enabling full milestone details associated with the particular node of the one or more nodes to be displayed when the particular node of the one or more nodes is selected.

6. The computing device-implemented method of claim 1, further comprising:
receiving task information associated with the project;
generating a progress management model based on the milestone information, the task information, and the dependency information; and
providing the progress management model for display.

7. A computing device-implemented method, comprising:
receiving task information and dependency information associated with a project;
generating a task flow chart based on the task information and the dependency information;
representing one or more tasks, in the task flow chart, with one or more nodes;
representing one or more dependencies among the one or more tasks with one or more directed arcs provided between corresponding nodes of the one or more nodes;
calculating a critical path associated with the one or more tasks;
representing the critical path with bolded directed arcs provided between corresponding nodes of the one or more nodes; and
providing the task flow chart, including the representations of the one or more tasks, the one or more dependencies, and the critical path, for display.

8. The computing device-implemented method of claim 7, further comprising:
storing the task information and the dependency information in one or more templates, as sequences of tasks and task dependencies; and
converting the one or more templates into the task flow chart.

9. The computing device-implemented method of claim 8, where each of the one or more templates comprises an extensible markup language (XML) template.

10. The computing device-implemented method of claim 7, where the task flow chart is provided for display via a web-based user interface, and where the task flow chart supports multiple browser applications.

11. The computing device-implemented method of claim 7, further comprising one of:
enabling some task details associated with a particular node of the one or more nodes to be displayed when a mouseover operation is performed on the particular node of the one or more nodes; or
enabling full task details associated with the particular node of the one or more nodes to be displayed when the particular node of the one or more nodes is selected.

12. The computing device-implemented method of claim 7, further comprising:
providing, to users, one or more notifications associated with the task flow chart.

13. A device, comprising:
a memory to store a plurality of instructions; and
a processor to execute instructions in the memory to:
receive milestone information and dependency information associated with a project,
generate a milestone flow chart based on the milestone information and the dependency information,
represent one or more milestones, in the milestone flow chart, with one or more nodes,
represent one or more dependencies among the one or more milestones with one or more directed arcs provided between corresponding nodes of the one or more nodes,
calculate a critical path associated with the one or more milestones,
represent the critical path with bolded directed arcs provided between corresponding nodes of the one or more nodes, and
provide the milestone flow chart, including the representations of the one or more milestones, the one or more dependencies, and the critical path, for display.

14. The device of claim 13, where the processor further executes instructions in the memory to:
store, via the memory, the milestone information and the dependency information in one or more templates, as sequences of milestones and milestone dependencies, and convert the one or more templates into the milestone flow chart.

15. The device of claim 14, where each of the one or more templates comprises an extensible markup language (XML) template.

16. The device of claim 13, where the milestone flow chart is provided for display via a web-based user interface, and where the milestone flow chart supports multiple browser applications.

17. The device of claim 13, where the processor further executes instructions in the memory to one of:
enable some milestone details associated with a particular node of the one or more nodes to be displayed when a mouseover operation is performed on the particular node of the one or more nodes, or
enable full milestone details associated with the particular node of the one or more nodes to be displayed when the particular node of the one or more nodes is selected.

18. The device of claim 13, where the processor further executes instructions in the memory to:
receive task information associated with the project,
generate a progress management model based on the milestone information, the task information, and the dependency information, and
provide the progress management model for display.

19. The device of claim 13, where the milestone information comprises at least one of:
a baseline against which progress may be measured throughout the life of the project,
one or more project tasks,
one or more milestone names,
one or more milestone owners,
one or more milestone states,
one or more planned durations for milestones,
one or more milestone start dates,
one or more milestone due dates, or
one or more milestone end dates.

20. A device, comprising:
a memory to store a plurality of instructions; and
a processor to execute instructions in the memory to:
receive task information and dependency information associated with a project,
generate a task flow chart based on the task information and the dependency information,
represent one or more tasks, in the task flow chart, with one or more nodes,
represent one or more dependencies among the one or more tasks with one or more directed arcs provided between corresponding nodes of the one or more nodes,
calculate a critical path associated with the one or more tasks,
represent the critical path with bolded directed arcs provided between corresponding nodes of the one or more nodes,
provide the task flow chart, including the representations of the one or more tasks, the one or more dependencies, and the critical path, for display,
execute, automatically, the one or more tasks to completion, and
represent completion of the one or more tasks on the task flow chart.

21. The device of claim 20, where the processor further executes instructions in the memory to:
store, via the memory, the task information and the dependency information in one or more templates, as sequences of tasks and task dependencies, and
convert the one or more templates into the task flow chart.

22. The device of claim 21, where each of the one or more templates comprises an extensible markup language (XML) template.

23. The device of claim 20, where the task flow chart is provided for display via a web-based user interface, and where the task flow chart supports multiple browser applications.

24. The device of claim 20, where the processor further executes instructions in the memory to one of:
enable some task details associated with a particular node of the one or more nodes to be displayed when a mouseover operation is performed on the particular node of the one or more nodes; or
enable full task details associated with the particular node of the one or more nodes to be displayed when the particular node of the one or more nodes is selected.

25. A computer-readable memory device that stores computer-executable instructions, the computer-readable memory device comprising:
one or more instructions to receive milestone information, task information, and dependency information associated with a project;
one or more instructions to generate a flow chart associated with the project based on the milestone information, the task information, and the dependency information;
one or more instructions to represent one or more tasks or milestones, in the flow chart, with one or more nodes;
one or more instructions to represent one or more dependencies among the one or more tasks or milestones with one or more directed arcs provided between corresponding nodes of the one or more nodes;
one or more instructions to calculate a critical path associated with the one or more tasks or milestones;
one or more instructions to represent the critical path with bolded directed arcs provided between corresponding nodes of the one or more nodes; and
one or more instructions to provide the flow chart, including the representations of the one or more tasks or milestones, the one or more dependencies, and the critical path, for display.
